(19) United States
(12) Patent Application Publication
(10) Pub. No.: US 2013/0326551 A1
(43) Pub. Date: Dec. 5, 2013

(54) WIRELESS MULTIMEDIA QUALITY OF EXPERIENCE REPORTING

(71) Applicants: Debdeep Chatterjee, Santa Clara, CA (US); Youn Hyoung Heo, Seoul (KR); Ozgur Oyman, San Jose, CA (US); Apostolos Papathanassiou, San Jose, CA (US)

(72) Inventors: Debdeep Chatterjee, Santa Clara, CA (US); Youn Hyoung Heo, Seoul (KR); Ozgur Oyman, San Jose, CA (US); Apostolos Papathanassiou, San Jose, CA (US)

(21) Appl. No.: 13/674,617

(22) Filed: Nov. 12, 2012

Related U.S. Application Data
(60) Provisional application No. 61/653,369, filed on May 30, 2012.

(51) Int. Cl. H04N 21/24

(52) U.S. Cl. CPC H04N 21/24
USPC 725/9

(57) ABSTRACT

Embodiments of techniques and systems for quality of experience (QoE) reporting in wireless systems are described. In some embodiments, user equipment may receive a first value of a first quality of experience (QoE) metric computed during playout of a multimedia asset at the user equipment. The first value may be received at a first layer in a protocol stack of the user equipment from a second layer above the first layer in the protocol stack. The user equipment may provide a first layer report, including data representative of the first value, for wireless transmission from the user equipment to an eNB. Other embodiments may be described and claimed.

### CROSS-REFERENCE TO RELATED APPLICATION

This application claims priority to U.S. Provisional Application No. 61/653,369, filed May 30, 2012, entitled “Advanced Wireless Communication Systems and Techniques,” which is hereby incorporated by reference herein in its entirety.

### TECHNICAL FIELD

The present disclosure relates generally to multimedia delivery in wireless communication networks, and more particularly, to techniques and systems for reporting quality of experience (QoE) metric values between wireless devices and base stations.

### BACKGROUND

In wireless multimedia communications, a user's QoE may be degraded by any of a number of factors, including high distortion levels, limited bandwidth, excessive delay, power constraints, and computational complexity limitations. Some existing technologies attempt to improve QoE by adapting application layer properties in response to varying network conditions (e.g., changing the bit rate of a streaming video service). However, such technologies may be limited in the frequency with which QoE information can be obtained and may fail to achieve desired performance.

### BRIEF DESCRIPTION OF THE DRAWINGS

Embodiments will be readily understood by the following detailed description in conjunction with the accompanying drawings. To facilitate this description, like reference numerals designate like structural elements. Embodiments are illustrated by way of example, and not by way of limitation, in the figures of the accompanying drawings.

FIG. 1 is a schematic diagram illustrating an example wireless communication environment for QoE reporting, in accordance with various embodiments.

FIG. 2 is a block diagram illustrating an example wireless device configured for QoE reporting, in accordance with various embodiments.

FIG. 3 is a block diagram illustrating an example base station configured for receiving QoE reports, in accordance with various embodiments.

FIG. 4 is a flow diagram of an example QoE report process executable by a wireless device, in accordance with various embodiments.

FIG. 5 is a signal flow diagram of an example QoE RRC-layer report process, in accordance with various embodiments.

FIG. 6 is a flow diagram of an example QoE report triggering process executable by a wireless device, in accordance with various embodiments.

FIG. 7 is a flow diagram of an example QoE report process executable by a base station, in accordance with various embodiments.

FIG. 8 is a block diagram of an example computing device suitable for practicing the disclosed embodiments, in accordance with various embodiments.

### DETAILED DESCRIPTION

Embodiments of techniques and systems for quality of experience (QoE) reporting in wireless systems are described. In some embodiments, user equipment may receive a first value of a first QoE metric computed during playout of a multimedia asset at the user equipment. The first value may be received at a first layer in a protocol stack of the user equipment from a second layer above the first layer in the protocol stack. The user equipment may provide a first layer report, including data representative of the first value, for wireless transmission from the user equipment to a base station.

Various embodiments of the QoE reporting techniques and systems described herein may be advantageously used in a number of applications to improve user QoE and increase service quality. In some embodiments, resource management strategies that consider the specific characteristics of video applications may be implemented at the lower layers of the protocol stack (e.g., physical (PHY) layer, medium access control (MAC) layer, network (NET) and transport layers). In some embodiments, adaption may occur at the radio and network levels in order to improve lower layer (e.g., PHY, MAC or NET) functions such as link adaptation and resource allocation by exploiting knowledge of various application layer characteristics associated with multimedia content and/or service. For example, knowledge of the rate-distortion characteristics of a video stream may allow the performance of QoE-aware scheduling at the PHY or MAC layer(s) to enhance video quality. Various embodiments of the techniques and systems disclosed herein may be beneficial for detecting and debugging failures, managing streaming performance, enabling intelligent client adaptation (which may be useful for device manufacturers), as well as allowing for QoE-aware network adaptation and service provisioning (which may be useful for network operators and content/service providers).

In the following detailed description, reference is made to the accompanying drawings which form a part hereof wherein like numerals designate like parts throughout, and in which is shown by way of illustration embodiments that may be practiced. It is to be understood that other embodiments may be utilized and structural or logical changes may be made without departing from the scope of the present disclosure. Therefore, the following detailed description is not to be taken in a limiting sense, and the scope of embodiments is defined by the appended claims and their equivalents.

Various operations may be described as multiple discrete actions or operations in turn, in a manner that is most helpful in understanding the claimed subject matter. However, the order of description should not be construed as to imply that these operations are necessarily order dependent. In particular, these operations may not be performed in the order of presentation. Operations described may be performed in a different order than the described embodiment. Various additional operations may be performed and/or described operations may be omitted in additional embodiments.

For the purposes of the present disclosure, the phrases “A and/or B” and “A or B” mean (A), (B), or (A and B). For the purposes of the present disclosure, the phrase “A, B, and/or C” means (A), (B), (C), (A and B), (A and C), (B and C), or (A, B and C).

The description may use the phrases “in an embodiment,” or “in embodiments,” which may each refer to one or more of the same or different embodiments. Furthermore, the terms “comprising,” “including,” “having,” and the like, as used with respect to embodiments of the present disclosure, are synonymous.

As may be used herein, the term “module” may refer to, be part of, or include an Application Specific Integrated Circuit (ASIC), an electronic circuit, a processor (shared, dedicated, or group) and/or memory (shared, dedicated, or group) that execute one or more software or firmware programs, a combinational logic circuit, and/or other suitable components that provide the described functionality.

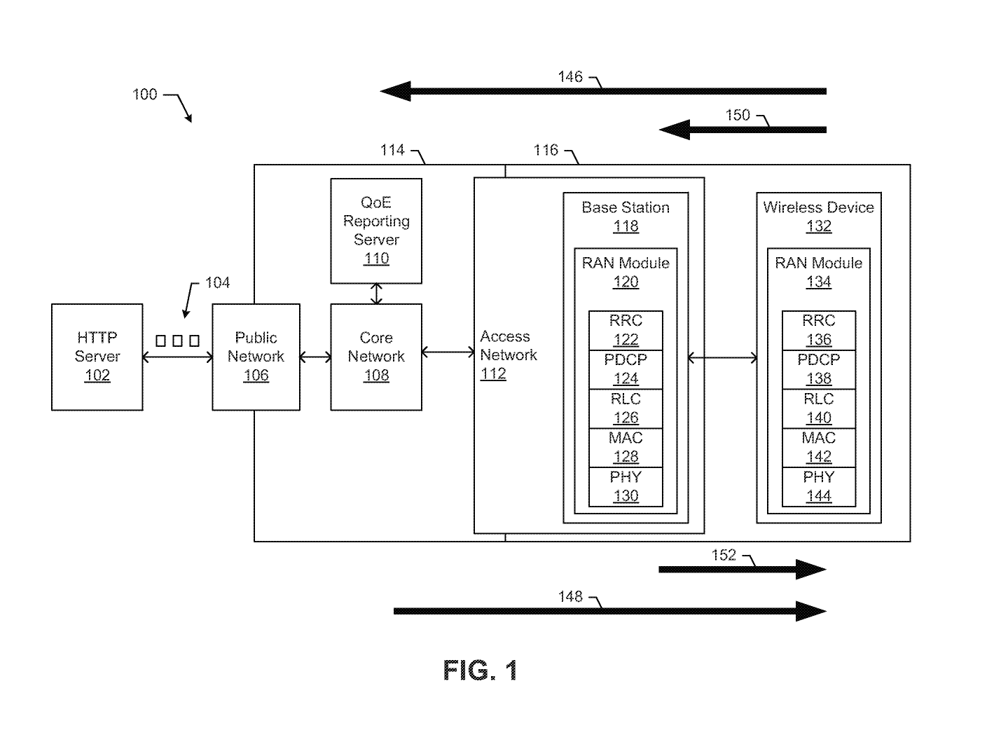

Referring now to FIG. 1, an example communication environment 100 is illustrated, in accordance with various embodiments. Communication environment 100 may include HTTP server 102, which may be configured to transmit multimedia content 104 to IP network 114. The use of an HTTP server in FIG. 1 is purely illustrative, and any of a number of content/service provision systems may be used with the techniques and systems disclosed herein, including live streaming over RTP, conversational services (e.g., video conferencing), and TV broadcasting, for example. IP network 114 may include public network 106 (e.g., the Internet), core network 108, QoE reporting server 110 and access network 112. Access network 112 may be an interface between IP network 114 and wireless network 116, and may include base station 118. Wireless network 116 may include part of access network 112, base station 118, and wireless device 132. Access network 112 may implement one or more wireless communication protocols, including 3GPP LTE (which includes revisions and updates such as LTE-Advanced), 802.16 (WiMAX), 3G, 4G, cellular network protocols and WWAN protocols.

Communication environment 100 may be configured for QoE reporting. In some embodiments, QoE reporting server 110 may transmit a trigger signal 148 to trigger the reporting of QoE information from wireless device 132. In some embodiments, base station 118, which may include or be included in an enhanced NodeB (“eNB,” also called “evolved Node B” or “eNodeB”) in 3GPP LTE embodiments, may transmit a trigger signal 152 to trigger the reporting of QoE information from wireless device 132. In some embodiments, both QoE reporting server 110 and base station 118 may trigger QoE reporting. As part of or separate from a trigger signal, the triggering system (e.g., QoE reporting server 110 and/or base station 118) may specify one or more QoE metrics to be reported. As part of or separate from a trigger signal, the triggering system may specify the reporting framework to be used by wireless device 132 when reporting QoE information. In some embodiments, a trigger signal may be transmitted and received internal to wireless device 132 (not shown in FIG. 1). As discussed herein, in various embodiments, reporting triggers may be periodic or aperiodic, explicit or implicit (e.g., a trigger requesting an immediate one-time report or a report initiated when a particular QoE metric value crosses a threshold), or any combination.

Wireless device 132 may monitor or measure one or more QoE metrics to be reported and may transmit a report that includes data representative of the values of the one or more QoE metrics. In some embodiments, wireless device 132 may transmit the report via signal 146 to QoE reporting server 110. In some embodiments, wireless device 132 may transmit the report via signal 150 to base station 118. In some embodiments, wireless device 132 may transmit reports with the same or different data to both QoE reporting server 110 and base station 118. The QoE metric values included in the report and the formatting of the report may be specified by the triggering systems, as discussed above.

Wireless network 116 may implement a radio communication protocol that is functionally represented by a number of layers in a protocol stack. For example, base station 118 may include radio access network (RAN) module 120 with radio resource control (RRC) layer 122, packet data convergence protocol (PDCP) layer 124, radio link control (RLC) layer 126, MAC layer 128 and PHY layer 130. Wireless device 132 may include RAN module 134 with RRC layer 136, PDCP layer 138, RLC layer 140, MAC layer 142 and PHY layer 144. In various embodiments of the techniques and systems described herein, as discussed in detail below, values of QoE metrics are transmitted from a higher layer in the protocol stack to a lower layer, then wirelessly transmitted in a report from the lower layer. Communication between layers may take place, for example, through an appropriate application programming interface (API).

The components of wireless communication environment 100 may take any of a number of forms. For example, public network 106 may include any public network such as the Internet, a telephone network (e.g., public switched telephone network (PSTN)), a local area network (LAN), a cable network, and/or another wireless network. Core network 108 may be connected to public network 106 via connection to an Ethernet, a digital subscriber line (DSL), a telephone line, a coaxial cable, and/or any wireless connection, etc. In some embodiments, communication environment 100 includes a private network instead of or in addition to public network 106.

Wireless device 132, which may also be referred to as user equipment (UE), may include any of a number of wireless electronic devices such as a desktop computer, a laptop computer, a handheld computer, a tablet computer, a cellular telephone, a pager, an audio and/or video player (e.g., an MP3 player or a DVD player), a gaming device, a video camera, a digital camera, a navigation device (e.g., a GPS device), a wireless peripheral (e.g., a printer, a scanner, a headset, a keyboard, a mouse, etc.), a medical device (e.g., a heart rate monitor, a blood pressure monitor, etc.), and/or other suitable fixed, portable, or mobile electronic devices. Although FIG. 1 depicts a single wireless device 132, communication environment 100 may include more wireless devices.

Communication environment 100 may include other wireless personal area network (WPAN), wireless local area network (WLAN), wireless metropolitan area network (WMAN), and/or wireless wide area network (WWAN) devices such as network interface devices and peripherals (e.g., network interface cards (NICs)), access points (APs), redistribution points, end points, gateways, bridges, hubs, etc. to implement a cellular telephone system, a satellite system, a personal communication system (PCS), a two-way radio system, a one-way pager system, a two-way pager system, a personal computer (PC) system, a personal data assistant (PDA) system, a personal computing accessory (PCA) system, and/or any other suitable communication system. While embodiments may described in the context of LTE networks, embodiments may also be employed in other networks (e.g., WiMAX networks).

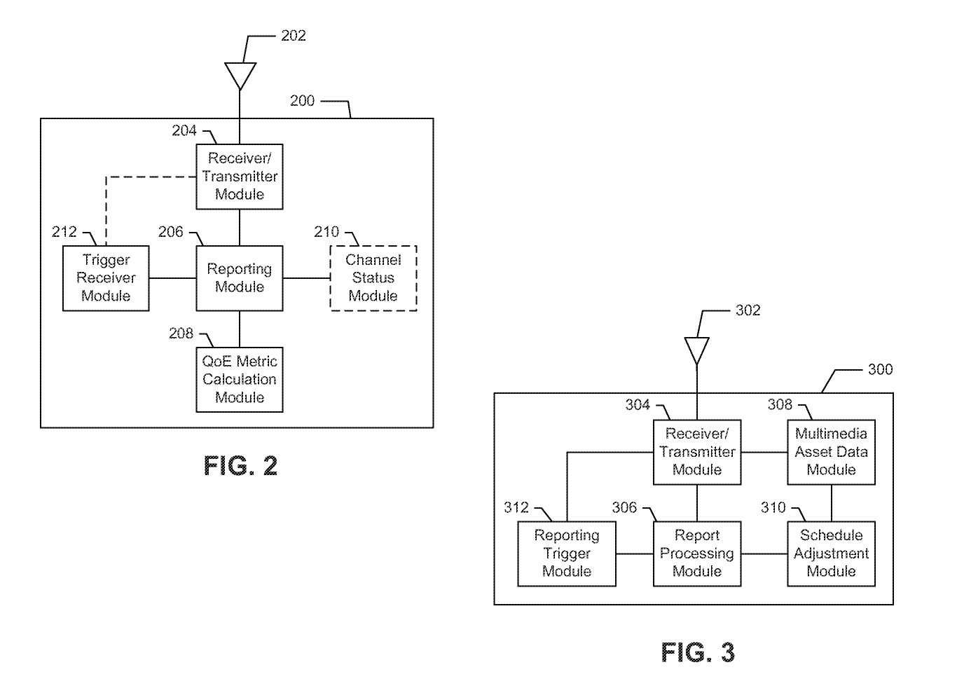

Referring now to FIG. 2, an example wireless device 200 for QoE reporting is illustrated, in accordance with various embodiments. The components of wireless device 200, discussed in detail below, may be included in wireless device 132 of FIG. 1, and vice versa. In particular, the components of wireless device 200 may operate with respect to a protocol stack such as that described above with reference to RAN module 134 of FIG. 1. In some embodiments, wireless device 200 is a mobile wireless device, such as a PDA, cellular telephone, tablet computer or laptop computer.

Wireless device 200 may include antenna 202. Antenna 202 may include one or more directional or omni-directional antennas such as dipole antennas, monopole antennas, patch antennas, loop antennas, microstrip antennas, and/or other types of antennas suitable for reception of radio frequency (RF) or other wireless communication signals. Although FIG. 2 depicts a single antenna, wireless device 200 may include additional antennas.

Wireless device 200 may include receiver/transmitter module 204. Antenna 202 may be coupled to receiver/transmitter module 204. Receiver/transmitter module 204 may be configured for receiving and transmitting wireless signals to and from other devices, such as any of the devices discussed above with reference to FIG. 1. For example, receiver/transmitter module 204 may be configured to receive wireless signals from a base station (such as base station 300 of FIG. 3, discussed below) conveying data representative of a multimedia asset to be played out by wireless device 200.

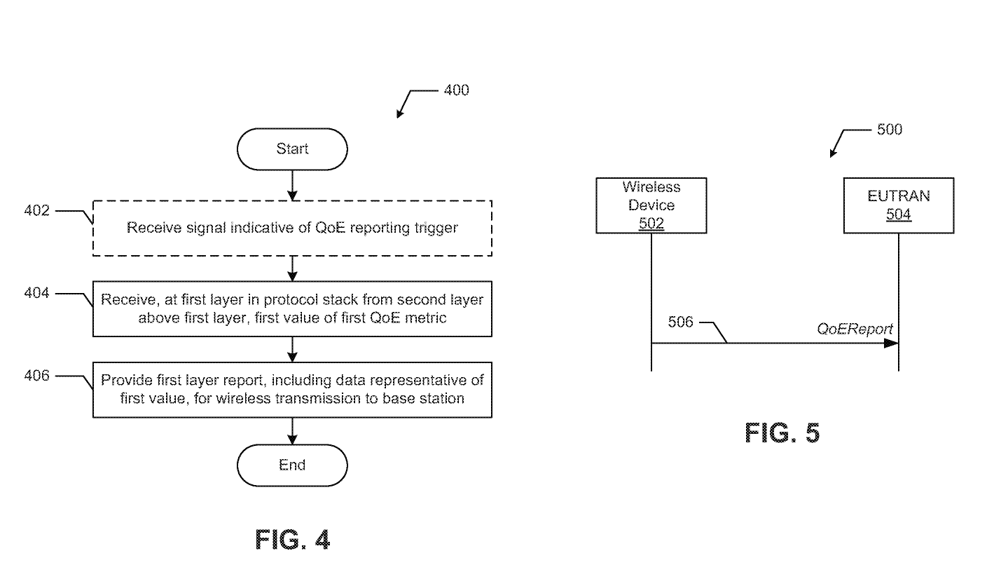

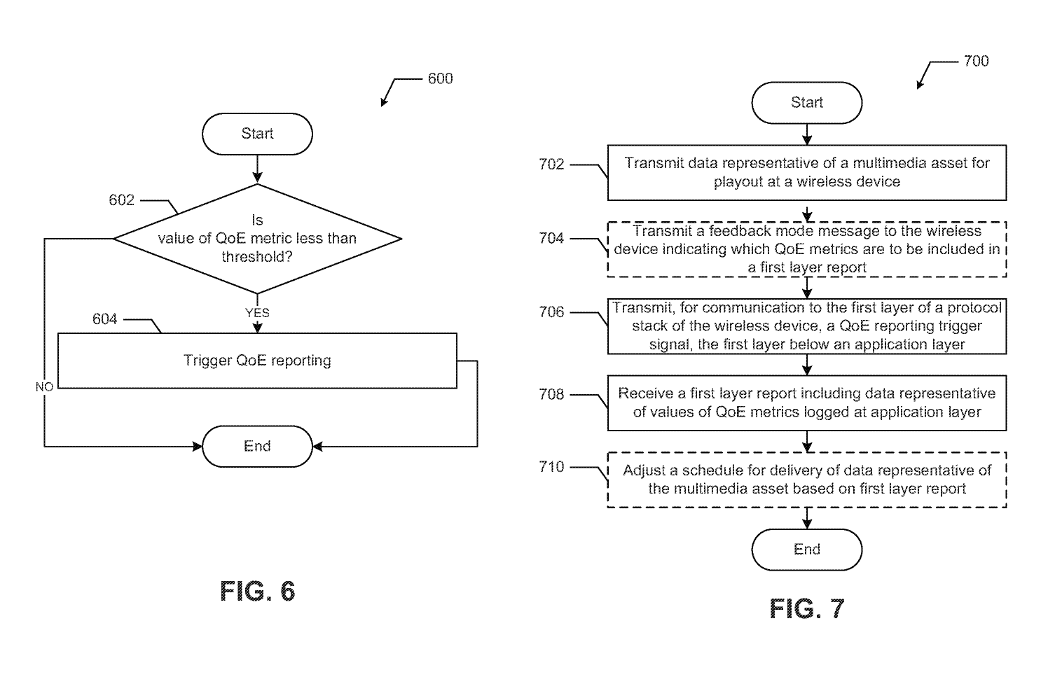

Wireless device 200 may include trigger receiver module 212. Trigger receiver module 212 may be coupled to reporting module 206. In some embodiments, trigger receiver module 212 may be coupled to receiver/transmitter module 204 (e.g., when reporting triggers are received via wireless transmission from an external device, such as a base station), but in other embodiments, trigger receiver module 212 may not be coupled to receiver/transmitter module 204 (e.g., when reporting triggers are received from within wireless device 200). Trigger receiver module 212 may be configured to receive a signal indicative of a QoE reporting trigger, in response to which wireless device 200 may transmit a report via reporting module 206 including values of one or more QoE metrics, as discussed below. Embodiments of QoE reporting triggers are discussed in additional detail below with reference to FIGS. 4 and 6.

Wireless device 200 may include QoE metric calculation module 208. QoE metric calculation module 208 may be coupled to reporting module 206. QoE metric calculation module 208 may be configured to calculate values for one or more QoE metrics that may be reported to an external device (e.g., a base station). In some embodiments, the one or more QoE metrics calculated by QoE metric calculation module 208 may include a buffer level, which provides a list of buffer occupancy level measurements carried out during playout. As part of a buffer level metric, QoE metric calculation module 208 may measure and report the buffer level that indicates the playout duration for which multimedia data is available, starting from the current playout time along with the time of the measurement of the buffer level. In some embodiments, from a buffer level measurement, QoE metric calculation module 208 may measure and report a rebuffering percentage, which may represent the percentage of the total presentation time in which the user experiences rebuffering due to buffer starvation. In some embodiments, the one or more QoE metrics calculated by QoE metric calculation module 208 may include a frame loss percentage, a rate distortion characteristic, a video quality metric, a peak signal-to-noise ratio, a structural similarity metric, a perceptual evaluation of video quality metric, a video mean opinion score, an initial playout delay, and other subjective quality metrics, for example.

Wireless device 200 may include channel state module 210. Channel state module 210 may be coupled to reporting module 206. Channel state module may be configured to provide channel state information (CSI) to reporting module 206 for transmitting to a base station or other device, for example, in a report. In some embodiments, CSI may include one or more of rank indication (RI) information, precoder matrix indication (PMI) information, and channel-quality indication (CQI) information, as specified in the 3GPP LTE standard. Channel state module 210 may provide different types of information under different conditions. For example, when wireless device 200 is not communicating in a spatial-multiplexing transmission mode according to the 3GPP LTE specifications, an RI report may not be included in the CSI provided to reporting module 206. Channel state module 210 may provide CSI periodically or aperiodically. In some embodiments, whether CSI is provided periodically or aperiodically may be specified by a base station (such as base station 300 of FIG. 3, discussed below).

Wireless device 200 may include reporting module 206. Reporting module 206 may be coupled to receiver/transmitter module 204, trigger receiver module 212, QoE metric calculation module 208 and channel state module 210. Reporting module 206 may be configured to receive, at a first layer in a protocol stack of wireless device 200, a first value of a first QoE metric calculated by QoE metric calculation module 208. The first value may come from a second layer in the protocol stack above the first layer. For example, in some embodiments, the first layer may be the PHY layer, the MAC layer or the RRC layer, and the second layer may be an application layer. In some embodiments, the first layer may receive the first value of the first QoE metric from the second layer through an appropriate API. Various embodiments of operations that may be performed by reporting module 206 are described in detail below (e.g., with reference to FIG. 4).

Referring now to FIG. 3, an example base station 300 configured for receiving QoE reports is illustrated, in accordance with various embodiments. The components of base station 300, discussed in detail below, may be included in base station 118 of FIG. 1, and vice versa. In particular, the components of base station 300 may operate with respect to a protocol stack such as that described above with reference to RAN module 120 of FIG. 1.

Base station 300 may include antenna 302. Antenna 302 may take any of the forms discussed above with reference to antenna 202 (FIG. 2). Although FIG. 3 depicts a single antenna, base station 300 may include additional antennas. Base station 300 may include receiver/transmitter module 304. Antenna 302 may be coupled to receiver/transmitter module 304. Receiver/transmitter module 304 may be configured for receiving and transmitting wireless signals to and from wireless devices, such as any of the devices discussed above with reference to FIGS. 1 and 2.

Base station 300 may include reporting trigger module 312. Reporting trigger module 312 may be coupled to receiver/transmitter module 304 and to report processing module 306. In some embodiments, reporting trigger module 312 may be configured to transmit, to a wireless device served by base station 300 (such as wireless device 200 of FIG. 2), a QoE reporting trigger signal. The QoE reporting trigger signal may be transmitted to the wireless device for communication to a first layer of a protocol stack of the wireless device. In some embodiments, the first layer may be a PHY layer, a MAC layer, or an RRC layer. QoE reporting trigger signals may be transmitted to the wireless device periodically or aperiodically. In some embodiments, reporting trigger module 312 may be configured to transmit, for communication to the first layer of the wireless device, a feedback mode message indicating which QoE metrics are to be included in a first layer report. In some embodiments, the feedback mode message may be a CSI feedback mode message.

Base station 300 may include report processing module 306. Report processing module 306 may be coupled to reporting trigger module 312, receiver/transmitter module 304 and schedule adjustment module 310. In some embodiments, report processing module 306 may be configured to receive and process a first layer report from a wireless device (such as wireless device 200 of FIG. 2) including data representative of the values of one or more QoE metrics (which may be specified, e.g., by a feedback mode message transmitted by reporting trigger module 312, as discussed above). In some embodiments, the first layer report may include data representative of the values of one or more QoE metrics logged by the wireless device during playout of a multimedia asset. As discussed above with reference to trigger receiver module 212 (FIG. 2), first layer reports may be received periodically or aperiodically.

Base station 300 may include multimedia asset data module 308. Multimedia asset data module 308 may be coupled to receiver/transmitter 304 and schedule adjustment module 310. In some embodiments, multimedia asset data module 308 is configured to transmit, to a wireless device served by base station 300 (such as wireless device 200 of FIG. 2), data representative of a multimedia asset for playout at the wireless device. Multimedia asset data module 308 may receive multimedia asset data from any of a number of sources (e.g., HTTP server 102 of FIG. 1) and may transmit data representative of the multimedia asset to the wireless device. Multimedia asset data module 308 may also provide information about attributes of the multimedia asset (e.g., bitrate, resolution, quality ranking and codec-related media information such as profile and level) to schedule adjustment module 310.

Base station 300 may include schedule adjustment module 310. Schedule adjustment module 310 may be coupled to report processing module 306 and multimedia asset data module 308. In some embodiments, schedule adjustment module 310 may adjust a schedule for the delivery of data representative of a multimedia asset based on a first layer report from a wireless device and processed by report processing module 306. Various embodiments of schedule adjustments that may be performed by schedule adjustment module 310 are described below.

Referring now to FIG. 4, a flow diagram of an example QoE report process 400 executable by a wireless device (e.g., wireless device 200 of FIG. 2) is illustrated, in accordance with various embodiments. It may be recognized that, while the operations of process 400 (and the other processes described herein) are arranged in a particular order and illustrated once each, in various embodiments, one or more of the operations may be repeated, omitted or performed out of order. For illustrative purposes, operations of process 400 may be described as performed by wireless device 200 (FIG. 2), but process 400 may be performed by any suitably configured device (e.g., wireless device 132 of FIG. 1, a programmed processing system, an ASIC, or another wireless computing device).

Process 400 may begin at optional operation 402, in which wireless device 200 may receive a signal indicative of a QoE reporting trigger. In some embodiments, operation 402 may be performed by processing circuitry included in trigger receiver module 212 (FIG. 2). In some embodiments, the signal indicative of a QoE reporting trigger received at operation 402 may initiate a periodic reporting of QoE metrics from wireless device 200 for a specified duration of time or until signaled otherwise. In some embodiments, the signal indicative of a QoE reporting trigger received at operation 402 may occur aperiodically. For example, in some embodiments, the signal indicative of a QoE reporting trigger received at operation 402 may include a QoE reporting request signal transmitted from a base station (e.g., base station 300 of FIG. 3). In some embodiments, the QoE reporting request signal may be a request for aperiodic feedback transmitted to wireless device 200 from a base station in an uplink grant corresponding to a physical uplink shared channel (PUSCH). A request for aperiodic QoE feedback transmitted in an uplink grant corresponding to a PUSCH may be included, in some embodiments, as part of a request for aperiodic feedback of CSI (which may be provided to reporting module 206 by channel status module 210 of FIG. 2). In some embodiments, the QoE reporting request signal may be separate from a CSI request signal. In some embodiments, the signal indicative of a QoE reporting trigger received at operation 402 occurs based on a comparison of a QoE metric value to a predetermined threshold for that QoE metric. Additional examples of such embodiments are described in detail below with reference to FIG. 6.

At operation 404, wireless device 200 may receive at a first layer in the protocol stack, from a second layer above the first layer in the protocol stack, a first value of a first QoE metric computed during playout of a multimedia asset at wireless device 200. In some embodiments, operation 402 may be performed by processing circuitry included in QoE metric calculation module 208 (FIG. 2). In some embodiments, the first layer may receive the first value of the first QoE metric from the second layer through an appropriate API. The first QoE metric whose value is calculated at operation 404 may include any of the QoE metrics discussed above with reference to QoE metric calculation module 208 (FIG. 2), or any other QoE metric. In some embodiments, the first value of the first QoE metric received at the first layer at operation 404 may include a one-bit indicator to provide an indication of a playout buffer occupancy with respect to a predetermined playout buffer occupancy threshold. For example, the one-bit indicator may take the value “1” when the playout buffer occupancy drops below a predetermined playout buffer occupany threshold (e.g., 50%), and may take the value “0” otherwise.

In some embodiments, the first value of the first QoE metric received at operation 404 may be a filtered value (e.g., a windowed average) based on two or more measurements of the first QoE metric. Filtering may be more appropriate for some QoE metrics (e.g., an absolute buffer occupany measurement), and less so for others (e.g., those that are represented by a one-bit indicator). In some embodiments in which the 3GPP LTE communication protocol is implemented, Layer 3 filtering may or may not be configured. This may be indicated by the filterCoefficient parameter associated with a QoE metric as configured by a base station (e.g., base station 300 of FIG. 3) using the QuantityConfig information element (IE). For example, when the first QoE metric is a video client buffer level, the QuantityConfig IE may take the form indicated by the example ASN1 code of Table 1 below.

TABLE 1
Example ASN1 code for a QuantityConfig IE.

| | |
|---|---|
| - - ASN1START | |
| QuantityConfig : := | SEQUENCE { |

| | | | |
|---|---|---|---|
| quantityConfigEUTRA | QuantityConfigEUTRA | OPTIONAL, | - - Need ON |
| quantityConfigUTRA | QuantityConfigUTRA | OPTIONAL, | - - Need ON |
| quantityConfigGERAN | QuantityConfigGERAN | OPTIONAL, | - - Need ON |
| quantityConfigCDMA2000 | QuantityConfigCDMA2000 | OPTIONAL, | - - Need ON |
| . . ., | | | |
| [ [ quantityConfigUTRA-v1200 | QuantityConfigUTRA-v1020 | OPTIONAL | - - Need ON |
| ] ] | | | |

| | |
|---|---|
| } | |
| QuantityConfigEUTRA : := | SEQUENCE { |

| | | |
|---|---|---|
| filterCoefficientRSRP | FilterCoefficient | DEFAULT fc4, |
| filterCoefficientRSRQ | FilterCoefficient | DEFAULT fc4, |
| filterCoefficientVidCntBuffLvl | FilterCoefficent | DEFAULT fc0 |

| | |
|---|---|
| } | |
| QuantityConfigUTRA : : = | SEQUENCE { |

| | | |
|---|---|---|
| measQuantityUTRA - FDD | ENUMERATED {cpich-RSCP, cpich-EcN0}, | |
| measQuantityUTRA - TDD | ENUMERATED {pccpch-RSCP}, | |
| filterCoefficient | FilterCoefficient | DEFAULT fc4 |

| | |
|---|---|
| } | |
| QuantityConfigUTRA-v1020 : := | SEQUENCE { |

| | | |
|---|---|---|
| filterCoefficient-FDD-r10 | FilterCoefficient | DEFAULT fc4 |

| | |
|---|---|
| } | |
| QuantityConfigGERAN : := | SEQUENCE { |

| | | |
|---|---|---|
| measQuantityGERAN | ENUMERATED {rssi}, | |
| filterCoeficient | FilterCoefficienit | DEFAULT fc2 |

| | |
|---|---|
| } | |
| QuantityConfigCDMA2000 : := | SEQUENCE { |

| | |
|---|---|
| measQuantityCDMA2000 | ENUMERATED (pilotStrength, pilotPnPhaseAndPilotStrength |

}
- - ASN1STOP

In some embodiments, the second layer (from which the first value of the first QoE metric is received at operation 404) may be an application layer. In some embodiments, the first value of the first QoE metric may be calculated at the application layer, and transmitted from the application layer to a layer below the application layer (e.g., the first layer of operation 404).

In some embodiments, the first layer may be a PHY layer. In some such embodiments, the first value of the first QoE metric may be a one-bit indicator of a value of a QoE metric with respect to a predetermined threshold, as discussed above with reference to playout buffer occupancy. In some embodiments, the first layer may be a MAC layer. In some embodiments, the first layer may an RRC layer. These and other embodiments of the first layer are discussed in additional detail herein.

At operation 406, wireless device 200 may provide a first layer report, including data representative of the first value, for wireless transmission from wireless device 200 to a base station (e.g., base station 300 of FIG. 3). In some embodiments, operation 406 may be performed by processing circuitry included in reporting module 206 (FIG. 2). In some embodiments, the first layer report may include a time stamp value indicative of a logging time of the first value. For example, in embodiments in which a QoE reporting request signal is received at operation 402, and that QoE reporting request signal includes an absolute time stamp value, the first layer report provided at operation 406 may include a relative time stamp value indicative of a logging time of the first value, the relative time stamp value relative to the absolute time stamp value of the QoE reporting request signal.

As discussed above with reference to operation 404, in some embodiments, the first layer may be a PHY layer. In some such embodiments, wireless device 200 may provide a first layer report periodically with a period of approximately 10 milliseconds or less. In some such embodiments, the data representative of the first value may include a one-bit indicator to provide an indication of a playout buffer occupancy with respect to a predetermined playout buffer occupancy threshold, as discussed above. In some such embodiments, the first layer report may also include CSI feedback (provided, e.g., by channel state module 210 of FIG. 2). Providing a first layer report from the PHY layer may be advantageous when the first layer report has a relatively small feedback payload size (e.g., when the QoE metric value is a one-bit indicator). When first layer reports are transmitted aperiodically, larger feedback payload sizes may be advantageously supported (e.g., an absolute amount of buffer occupancy or rebuffering percentage).

In some embodiments in which the first layer is a PHY layer, the first layer report may be provided for wireless transmission at operation 404 in a physical uplink control channel (PUCCH) between wireless device 200 and the base station. In some embodiments in which the first layer is a PHY layer, the first layer report for aperiodic QoE reporting may be provided for wireless transmission in a physical uplink shared channel (PUSCH) between the wireless device and the base station. In some such embodiments, the first report may be provided in response to a request for aperiodic feedback of QoE information received at wireless device 200 at operation 402 in an uplink grant corresponding to the PUSCH, as discussed above. In some embodiments in which the first layer report is provided in a PUSCH, the first layer report may include an absolute amount of playout buffer occupancy or a re-buffering percentage.

As discussed above with reference to operation 404, in some embodiments, the first layer may be a MAC layer. Providing first layer reports from the MAC layer may be advantageous in applications in which a higher payload size is desired than is suitable for use with a PHY layer report, for example. In some such embodiments, wireless device 200 may provide a first layer report periodically with a period between approximately 100 ms and 1 s. In some embodiments in which the first layer is a MAC layer, the first layer report may be provided for wireless transmission in a MAC control element. For example, the MAC control element may be transmitted in an uplink shared channel and may include a logical channel identity (LCID) value to indicate reporting of a QoE metric.

An illustrative example of an LCID assignment table is given below in Table 2. Table 2 illustrates an embodiment in which the multimedia asset is video and the first QoE metric is an absolute buffer level value. As shown, one of the indices reserved for LCID in the current 3GPP LTE standard may be redefined to indicate that the report includes video client buffer level reporting.

TABLE 2
Example values of LCID for uplink shared channel.

| Index | LCID Values |
|---|---|
| 00000 | Common Control Channel (CCCH) |
| 00001-01010 | Identity of the Logical Channel |
| 01011-10111 | Reserved |
| 11000 | Video Client Buffer Level Report |
| 11001 | Extended Power Headroom Report |
| 11010 | Power Headroom Report |
| 11011 | Cell Radio-Network Temporary Identifier (C-RNTI) |
| 11100 | Truncated Buffer Status Report (BSR) |
| 11101 | Short BSR |
| 11110 | Long BSR |
| 11111 | Padding |

As discussed above with reference to operation 404, in some embodiments, the first layer may be an RRC layer. Providing first layer reports from the RRC layer may be advantageous in applications in which a higher payload size is desired than is suitable for use with a PHY layer report, for example. In some such embodiments, wireless device 200 may provide a first layer report periodically with a period greater than approximately 2 seconds. Aperiodic reporting may be triggered explicitly via the RRC layer. The RRC layer may advantageously serve as the first layer with reference to process 400 when, for example, MAC layer QoE reporting is not feasible for long periods due to lack of available data in the uplink buffer. In some embodiments in which the first layer is an RRC layer, operation 404 may include wireless device 200 transmitting a scheduling request to the base station, and after an uplink grant for PUSCH (which may serve as a QoE reporting request signal per operation 402), providing the first layer report from the RRC layer. In some embodiments in which the first layer in an RRC layer and a 3GPP protocol is used, wireless device 200 may provide the logging time of the first value of the first QoE metric by using the relativeTimeStamp field in the UEInformationResponse IE that denotes the measurement logging time with respect to the absoluteTimeStamp value that is set to the value of the absoluteTimeInfo IE sent by the base station (e.g., an eNB).

In some embodiments, when the RRC layer serves as the first layer, wireless device 200 may report values for QoE metrics identified in a measId IE. For example, when the first QoE metric is a video client buffer level, the first layer report may include the MeasResults IE indicated by the example ASN1 code of Table 3. In some embodiments, the QoE metric(s) represented in the first layer report may be represented once for each component carrier with which wireless device 200 is configured. This may be in contrast to reference signal received power (RSRP) and reference signal received quality (RSRQ) measurements, which may be performed not only for serving cells, but also for neighboring cells (e.g., for mobility management purposes, etc.).

TABLE 3
Example ASN1 code for a MeasResults IE.

| | |
|---|---|
| - - ASN1START | |
| measResults : := | SEQUENCE { |

| | |
|---|---|
| measId | MeasId, |

| | |
|---|---|
| measResultPCell | SEQUENCE |

| | |
|---|---|
| rsrpResult | RSRP-Range, |
| rsrpResult | RSRQ-Range, |
| vidClntBuffLvlResult-r12 | VidClntBuffLvl-Range |

},

| | |
|---|---|
| measResultNeighCells | CHOICE { |

| | |
|---|---|
| measResultListEUTRA | MeasResultListEUTRA, |
| measResultListUTRA | MeasResultListUTRA, |
| measResultListGERAN | MeasResultListGERAN, |
| measResultsCDMA2000 | MeasResultsCDMA2000, |
| . . . | |

| | | |
|---|---|---|
| } | | OPTIONAL, |
| . . . , | | |
| [ [ measREsultForECID-r9 | MeasREsultForECID-r9 | OPTIONAL |
| ] ], | | |
| [ [ locationInfo-r10 | LocationInfo-r10 | OPTIONAL, |
| measResultServFreqList - r10 | measResultServFreqList - r10 | OPTIONAL |
| ] ] | | |
| } | | |

| | |
|---|---|
| MeasResultList EUTRA : := | SEQUENCE (SIZE 1..maxCellReport ) ) OF MeasResultEUTRA |
| MeasResultEUTRA : := SEQUENCE { | |

| | |
|---|---|
| physCellId | PhysCellId, |
| cgi - Info | SEQUENCE { |

| | | |
|---|---|---|
| cellGlobalId | CellGlobalIdEUTRA, | |
| trackingAreaCode | TrackingAreaCode, | |
| plmn-IdentityList | PLMN-IdentityList2 | OPTIONAL |

| | | |
|---|---|---|
| } | | OPTIONAL, |
| MeasResult | SEQUENCE { | |

| | | |
|---|---|---|
| rsrpResult | RSRP - Range | OPTIONAL, |
| rsrqResult | RSRQ - Range | OPTIONAL, |
| vidClntBuffLvlResult - r12 | VidClntBuffLvl - Range | OPTIONAL, |
| . . . , | | |
| [ [ addtionalSI-Info-r9 | AddtionalSI-Info-r9 | OPTIONAL |
| ] ] | | |

}

| | |
|---|---|
| } | |
| MeasResulServFreqList = r10 : : = | SEQUENCE (SIZE 1..maxSeCellr10)) OF MeasResultServFreq - r10 |
| MeasResultServFreq- r10 : := | SEQUENCE { |

| | |
|---|---|
| servFrqId - r10 | ServCellIndex - r10, |
| measResultSCell - r10 | SEQUENCE { |

| | |
|---|---|
| rsrpResultSCell - r10 | RSRP - Range, |
| rsrqResultSCell - r10 | RSRQ - Range |

| | | |
|---|---|---|
| } | | OPTIONAL, |
| measResultBestNegCell- r10 | SEQUENCE { | |

| | |
|---|---|
| physCellId - r10 | PhysCellId, |
| rsrpResultNCell - r10 | RSRP - Range, |
| rsrpResultNCell - r10 | RSRQ - Range |

| | |
|---|---|
| } | OPTIONAL, |
| . . . | |
| } | |

| MeasResultList ULTRA : : = | | SEQUENCE (SIZE 1..maxCellReport )) OF MeasResultUTRA |
|---|---|---|
| MeasResultUTRA : := SEQUENCE | | |
| | phyCellId | CHOICE { |

| | |
|---|---|
| fdd | PhysCellIdUTRA-FDD, |
| tdd | PhysCellIdUTRA-TDD |

| | |
|---|---|
| }, | |
| Cgi-Info | SEQUENCE { |

| | | |
|---|---|---|
| cellGlobalId | CellGlobalIdUTRA | |
| locationAreaCode | BIT STRING (SIZE (16)) | OPTIONAL, |
| routingAreaCode | BIT STRING (SIZE (8)) | OPTIONAL, |
| plmn-IdentityList | PLMN-IdentityList2 | OPTIONAL, |

| | | |
|---|---|---|
| } | | OPTIONAL, |
| measResult | SEQUENCE { | |

| | | |
|---|---|---|
| utra-RSCP | INTEGER (−5 . . 91) | OPTIONAL |
| utra-EcN0 | INTEGER (0 . .49) | OPTONAL, |
| . . ., | | |
| [ [ additionalSI-Info-r9 | AdditionalSI-Info-r9 | OPTIONAL |
| ] ] | | |

| | |
|---|---|
| } | |
| } | |
| MeasResultListGERAN : := | SEQUENCE (SIZE 1..maxCellReport )) OF MeasResultGERAN |
| MeasResultGERAN : := | SEQUENCE { |

| | |
|---|---|
| carrierFreq | CarrierFreqGERAN, |
| physCellID | PhysCellIdGERAN, |
| cgi - Info | SEQUENCE { |

| | | |
|---|---|---|
| cellGlobalId | CellGlobalIdGERRAN, | |
| routingAreaCode | BIT STRING (SIZE (8)) | OPTIONAL |

| | | |
|---|---|---|
| } | | OPTIONAL, |
| measResult | SEQUENCE { | |

| | |
|---|---|
| rssi | INTEGER (0 . .63), |
| . . . | |

| | |
|---|---|
| } | |
| } | |
| MeasResultCDMA2000 : := | SEQUENCE { |

| | |
|---|---|
| preRegistrationStatusHRPD | BOOLEAN, |
| measResultListCDMA2000 | MeasResultListCDMA2000 |

| | |
|---|---|
| } | |
| MeasResultListCDMA2000 : := | SEQUENCE (SIZE 1..maxCellReport )) OF MeasResultCDMA2000 |
| MeasResultCDMA2000 : := | SEQUENCE |

| | | |
|---|---|---|
| phyCellID | PhysCellIdCDMA2000, | |
| cgi - Info | CellGlobalIdCDMA2000 | OPTIONAL, |
| measResult | SEQUENCE { | |

| | | |
|---|---|---|
| pilotPnPhase | INTEGER (0 . .32767) | OPTIONAL, |
| pilotStrength | INTEGER (0 . .63), | |
| . . . | | |

| | |
|---|---|
| } | |
| } | |
| MeasResultFrECID-r9 : := | SEQUENCE { |

| | |
|---|---|
| Ue-RxTxTimeDiffResult - r9 | INTEGER (0 . .4095), |
| currentSFN - r9 | BIT STRING (SIZE (10)) |
| } | |

| PLMN-IdentityList2 : : = | | SEQUENCE (SIZE (1. .5) ) OF PLMN - Identity | |
|---|---|---|---|
| AdditionalSI-Info-r9 : := | | SEQUENCE { | |
| | csg-MemberStatus - r9 | ENUMERAED {member} | OPTIONAL |

| | | |
|---|---|---|
| csg-Identity - r9 | CSG-Identity | OPTIONAL, |

}
- - ASN1STOP

FIG. 5 is a signal flow diagram of example QoE RRC-layer report process 500, in accordance with various embodiments. In FIG. 5, wireless device 502 (which may include the components discussed above with reference to wireless device 200 of FIG. 2) may transmit a QoE report 506 to evolved UMTS Terrestrial Radio Access Network (EUTRAN) 504 (which may include, e.g., base station 118 of FIG. 1).

Referring now to FIG. 6, a flow diagram of example QoE report triggering process 600 executable by a wireless device is illustrated, in accordance with various embodiments. Process 600 may be performed, in some embodiments, in conjunction with operation 402 of FIG. 4. As discussed above with reference to FIG. 4, process 600 will be discussed for illustrative purposes as executed by wireless device 200 (FIG. 2).

Process 600 may begin at decision block 602, at which wireless device 200 may determine whether a value of a QoE metric is less than a threshold. For example, wireless device 200 may measure the buffer level of a video asset being played out at wireless device 200 and may compare the measured buffer level to a predetermined threshold. In some embodiments, the predetermined threshold may be configured by signals transmitted to, for example, the RRC layer or application layer of a base station, and may be specific to wireless device 200 or specific to a cell to which wireless device 200 belongs. For example, in some embodiments, a base station (such as base station 300 of FIG. 3) may determine and transmit a buffer occupancy threshold value to wireless device 200, which wireless device 200 may use as the threshold value at decision block 602. In some embodiments, the threshold may vary dependent on network conditions such as network load and the deployment scenario. For example, when network load is low, the threshold on minimum video buffer level may be set to a higher value to provide higher playout quality.

The QoE metric evaluated at decision block 602 may be the first QoE metric described above with reference to operation 404 of FIG. 4, or a different QoE metric. For example, when a video buffer level is determined to have fallen below a predetermined threshold, wireless device 200 may be configured to measure buffer levels, frame loss percentage and rebuffering percentage and transmit values of those metrics to a base station in a first layer report (as discussed above with reference to operations 404 and 406 of FIG. 4). In some embodiments, the analysis performed at decision block 602 may include comparing a number of QoE metrics to a corresponding number of thresholds, and proceeding to operation 604 only if a predetermined combination of threshold conditions is satisfied. For ease of illustration, only one threshold condition is discussed with reference to FIG. 6.

If wireless device 200 determines at decision block 602 that the value of the QoE metric is less than the threshold, wireless device 200 may proceed to execute operation 604 and provide a QoE reporting trigger. If wireless device 200 determines at decision block 602 that the value of the QoE metric is greater than the threshold, wireless device 200 may not provide a QoE reporting trigger and process 600 may end. It is understood that the use of a “less than” determination at decision block 602 is merely illustrative, and that a “greater than,” “equal to,” “approximately equal to,” or any other suitable analysis may be preferred for different QoE metrics.

Referring now to FIG. 7, a flow diagram of an example QoE report process 700 executable by a base station is illustrated, in accordance with various embodiments. For illustrative purposes, operations of process 700 may be described as performed by base station 300 (FIG. 3), but process 700 may be performed by any suitably configured device (e.g., base station 118 of FIG. 1, an eNB, a programmed processing system, an ASIC, or another computing device).

At operation 702, base station 300 may transmit, to a wireless device served by the base station (such as wireless device 200 of FIG. 2), data representative of a multimedia asset for playout at the wireless device. In some embodiments, operation 702 may be performed by processing circuitry included in multimedia asset data module 308 (FIG. 3). In some embodiments, the multimedia asset may have been transmitted to base station 300 from HTTP server 102 (FIG. 1) or another source of multimedia content. The multimedia asset whose data is transmitted at operation 702 may include any of the multimedia assets described herein, such as video assets, or any other multimedia asset.

At optional operation 704, base station 300 may transmit, to the wireless device, a feedback mode message indicating which QoE metrics are to be included in a first layer report to be transmitted by the wireless device during playout of the multimedia asset. In some embodiments, operation 704 may be performed by processing circuitry included in reporting trigger module 312 (FIG. 3). The feedback mode message may be, for example, a CSI feedback mode message. As discussed above with reference to FIG. 6, in some embodiments, a feedback mode message transmitted by base station 300 to the wireless device may include a threshold value for one or more QoE metrics, such as a buffer occupancy threshold value. The wireless device may compare measured QoE metric values against this threshold value to trigger the generation and/or transmission of QoE reports. In some embodiments, the feedback mode message transmitted at operation 704 may be cell-specific or wireless device-specific.

At operation 706, base station 300 may transmit, for communication to a first layer of a protocol stack of the wireless device below an application layer of the wireless device, a quality of experience (QoE) reporting trigger signal. In some embodiments, operation 706 may be performed by processing circuitry included in reporting trigger module 312 (FIG. 3). Any of the various embodiments of trigger signals disclosed herein (e.g., those discussed above with reference to operation 402 of FIG. 4) may be implemented at operation 706. For example, the first layer may be a PHY layer, a MAC layer, or an RRC layer.

At operation 708, base station 300 may receive, from the wireless device in response to the QoE reporting trigger signal transmitted at operation 706, a first layer report including data representative of the values of one or more QoE metrics logged at the application layer of the wireless device during playout of the multimedia asset. In some embodiments, operation 708 may be performed by processing circuitry included in reporting processing module 306 (FIG. 3). Any of the various embodiments of a first layer report disclosed herein (e.g., those discussed above with reference to operation 406 of FIG. 4) may be implemented at operation 708. For example, in some embodiments, the one or more QoE metrics represented in the first layer report may include a rate distortion characteristic of playout of the multimedia asset. In some embodiments in which the multimedia asset is played out via buffered streaming, the one or more QoE metrics represented in the first layer report may include a rebuffering percentage, which may represent the percentage of the total presentation time in which the user experiences rebuffering due to buffer starvation. The first layer report may also include other information from the first layer in addition to the data representative of the values of one or more QoE metrics (such as CSI information).

At optional operation 710, base station 300 may adjust a schedule for delivery of data representative of the multimedia asset based at least in part on the data representative of the values of the one or more QoE metrics in the first layer report. In some embodiments, operation 710 may be performed by processing circuitry included in schedule adjustment module 310 (FIG. 3). Any of a number of schedule adjustments may be made at operation 710. For example, in some embodiments, user scheduling, prioritization, and modulation and coding scheme (MCS) selection may be adjusted to enhance video quality based on QoE metric data that represents a rate-distortion characteristic of the transmitted video stream.

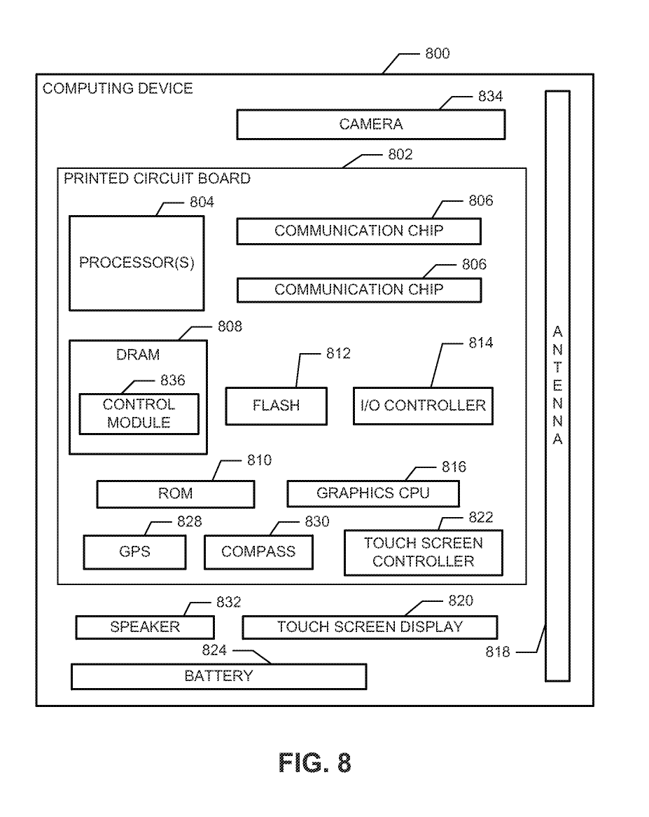

FIG. 8 is a block diagram of example computing device 800, which may be suitable for practicing various disclosed embodiments. Computing device 800 may include a number of components, including one or more processor(s) 804 and at least one communication chip 806. In various embodiments, processor 804 may include a processor core. In various embodiments, at least one communication chip 806 may also be physically and electrically coupled to processor 804. In further implementations, communication chips 806 may be part of processor 804. In various embodiments, computing device 800 may include PCB 802. For these embodiments, processor 804 and communication chip 806 may be disposed thereon. In alternate embodiments, the various components may be coupled without the employment of PCB 802.

Depending on its applications, computing device 800 may include other components that may or may not be physically and electrically coupled to PCB 802. These other components include, but are not limited to, volatile memory (e.g., dynamic random access memory 808, also referred to as DRAM), non-volatile memory (e.g., read-only memory 810, also referred to as “ROM,” one or more hard disk drives, one or more solid-state drives, one or more compact disc drives, and/or one or more digital versatile disc drives), flash memory 812, input/output controller 814, a digital signal processor (not shown), a crypto processor (not shown), graphics processor 816, one or more antenna 818, touch screen display 820, touch screen controller 822, other displays (such as liquid-crystal displays, cathode-ray tube displays and e-ink displays, not shown), battery 824, an audio codec (not shown), a video codec (not shown), global positioning system (GPS) device 828, compass 830, an accelerometer (not shown), a gyroscope (not shown), speaker 832, camera 834, and a mass storage device (such as hard disk drive, a solid state drive, compact disk (CD), digital versatile disk (DVD)) (not shown), and so forth. In various embodiments, processor 804 may be integrated on the same die with other components to form a System on Chip (SoC).

In various embodiments, volatile memory (e.g., DRAM 808), non-volatile memory (e.g., ROM 810), flash memory 812, and the mass storage device may include programming instructions configured to enable computing device 800, in response to execution by processor(s) 804, to practice all or selected aspects of the processes described herein. For example, one or more of the memory components such as volatile memory (e.g., DRAM 808), non-volatile memory (e.g., ROM 810), flash memory 812, and the mass storage device may include temporal and/or persistent copies of instructions that, when executed, enable computing device 800 to operate control module 836 configured to practice all or selected aspects of the processes described herein. Memory accessible to computing device 800 may include one or more storage resources that are physically part of a device on which computing device 800 is installed and/or one or more storage resources that is accessible by, but not necessarily a part of, computing device 800. For example, a storage resource may be accessed by computing device 800 over a network via communications chips 806.

Communication chips 806 may enable wired and/or wireless communications for the transfer of data to and from computing device 800. The term “wireless” and its derivatives may be used to describe circuits, devices, systems, methods, techniques, communication channels, etc., that may communicate data through the use of modulated electromagnetic radiation through a non-solid medium. The term does not imply that the associated devices do not contain any wires, although in some embodiments they might not. Many of the embodiments described herein may be used with WiFi and 3GPP/LTE communication systems. However, communication chips 806 may implement any of a number of wireless standards or protocols, including but not limited to IEEE 702.20, General Packet Radio Service (GPRS), Evolution Data Optimized (Ev-DO), Evolved High Speed Packet Access (HSPA+), Evolved High Speed Downlink Packet Access (HSDPA+), Evolved High Speed Uplink Packet Access (HSUPA+), Global System for Mobile Communications (GSM), Enhanced Data rates for GSM Evolution (EDGE), Code Division Multiple Access (CDMA), Time Division Multiple Access (TDMA), Digital Enhanced Cordless Telecommunications (DECT), Bluetooth, derivatives thereof, as well as any other wireless protocols that are designated as 3G, 4G, 5G, and beyond. Computing device 800 may include a plurality of communication chips 806. For instance, a first communication chip 806 may be dedicated to shorter range wireless communications such as Wi-Fi and Bluetooth and a second communication chip 806 may be dedicated to longer range wireless communications such as GPS, EDGE, GPRS, CDMA, WiMAX, LTE, Ev-DO, and others.

In various implementations, computing device 800 may be a laptop, a netbook, a notebook, an ultrabook, a smart phone, a computing tablet, a personal digital assistant, an ultra mobile PC, a mobile phone, a desktop computer, a server, a printer, a scanner, a monitor, a set-top box, an entertainment control unit (e.g., a gaming console), a digital camera, a portable music player, or a digital video recorder. In further implementations, computing device 800 may be any other electronic device that processes data.

The following paragraphs describe examples of various embodiments. In various embodiments, a user equipment includes a first module for receiving a signal indicative of a quality of experience (QoE) reporting trigger, a second module for receiving, at a first layer in a protocol stack of the user equipment, from a second layer above the first layer in the protocol stack, a first value of a first QoE metric computed during playout of a multimedia asset at the user equipment, and a third module for, in response to receiving the signal indicative of the QoE reporting trigger, providing a first layer report, including data representative of the first value, for wireless transmission from the user equipment to an eNB. The QoE reporting trigger may occur based on a comparison of the first value to a predetermined threshold for the first QoE metric. The predetermined threshold for the first QoE metric may be a buffer occupancy threshold value transmitted to the user equipment from the eNB. The QoE reporting trigger may initiate a periodic reporting of QoE metrics from the user equipment for a specified duration of time or until signaled otherwise. The QoE reporting trigger may include a QoE reporting request signal received at the user equipment from an eNB. The QoE reporting request signal may include an absolute time stamp value and the first layer report includes a relative time stamp value indicative of a logging time of the first value, the relative time stamp value relative to the absolute time stamp value. The first value of the first QoE metric may be a filtered value based on two or more measurements of the first QoE metric. The first QoE metric may be selected from the group consisting of a playout buffer occupancy measurement, a rebuffering percentage measurement, a frame loss percentage, a rate distortion characteristic, a video quality metric, a peak signal-to-noise ratio, a structural similarity metric, a perceptual evaluation of video quality metric, a video mean opinion score, and an initial playout delay.

In various embodiments, a user equipment includes circuitry configured to receive at a first layer in a protocol stack of the user equipment, from a second layer above the first layer in the protocol stack, a first value of a first quality of experience (QoE) metric computed during playout of a multimedia asset at the user equipment, and provide a first layer report, including data representative of the first value, for wireless transmission from the user equipment to an eNB. In some embodiments, the first layer may be a physical (PHY) layer. The data representative of the first value may include a one-bit indicator to provide an indication of a playout buffer occupancy with respect to a predetermined playout buffer occupancy threshold. In some embodiments, providing a first layer report occurs periodically with a period of approximately 10 milliseconds or less. The first layer report may include channel state information (CSI). The first layer report may be provided for wireless transmission in a physical uplink control channel (PUCCH) between the user equipment and the eNB. The first layer report may be provided for wireless transmission in a physical uplink shared channel (PUSCH) between the user equipment and the eNB. The circuitry may be further configured to receive, in an uplink grant corresponding to the PUSCH, a request for aperiodic feedback of QoE information. The first layer report may include an absolute amount of playout buffer occupancy or a re-buffering percentage. The request may also be for aperiodic feedback of CSI. In some embodiments, the first layer may be a medium access control (MAC) layer. Providing a first layer report may occur periodically with a period between approximately 100 ms and 1 s. The first layer report may be provided for wireless transmission in a MAC control element. The MAC control element may be transmitted in an uplink shared channel and includes a logical channel identity (LCID) value to indicate reporting of a QoE metric. In some embodiments, the first layer may be a radio resource control (RRC) layer. Providing a first layer report may occur periodically with a period greater than approximately 2 seconds. The second layer may be an application layer.

In various embodiments, at least one machine-accessible medium includes instructions stored thereon that are configured to cause an eNB, in response to execution of the instructions by the eNB, to: transmit, to a wireless device served by the eNB, data representative of a multimedia asset for playout at the wireless device; transmit, for communication to a first layer of a protocol stack of the wireless device below an application layer of the wireless device, a quality of experience (QoE) reporting trigger signal; and receive, from the wireless device in response to the QoE reporting trigger signal, a first layer report including data representative of the values of one or more QoE metrics logged at the application layer of the wireless device during playout of the multimedia asset. The at least one machine-accessible medium may further include instructions stored thereon that are configured to cause an eNB, in response to execution of the instructions by the eNB, to adjust a schedule for delivery of data representative of the multimedia asset based at least in part on the data representative of the values of the one or more QoE metrics in the first layer report. Playout of the multimedia asset may include buffered streaming of the multimedia asset and the one or more QoE metrics may include a rebuffering percentage. The at least one machine-accessible medium may further include instructions stored thereon that are configured to cause the eNB, in response to execution of the instructions by the eNB, to transmit, for communication to the first layer of the protocol stack of the wireless device, a channel state information (CSI) feedback mode message indicating which QoE metrics are to be included in the first layer report.

Computer-readable media (including non-transitory computer-readable media), methods, systems and devices for performing the above-described techniques are illustrative examples of embodiments disclosed herein. Additionally, other devices in the above-described interactions may be configured to perform various disclosed techniques.

Although certain embodiments have been illustrated and described herein for purposes of description, a wide variety of alternate and/or equivalent embodiments or implementations calculated to achieve the same purposes may be substituted for the embodiments shown and described without departing from the scope of the present disclosure. This application is intended to cover any adaptations or variations of the embodiments discussed herein. Therefore, it is manifestly intended that embodiments described herein be limited only by the claims.

Where the disclosure recites “a” or “a first” element or the equivalent thereof, such disclosure includes one or more such elements, neither requiring nor excluding two or more such elements. Further, ordinal indicators (e.g., first, second or third) for identified elements are used to distinguish between the elements, and do not indicate or imply a required or limited number of such elements, nor do they indicate a particular position or order of such elements unless otherwise specifically stated.

What is claimed is:

1. A user equipment, comprising:
a first module for receiving a signal indicative of a quality of experience (QoE) reporting trigger;
a second module for receiving, at a first layer in a protocol stack of the user equipment, from a second layer above the first layer in the protocol stack, a first value of a first QoE metric computed during playout of a multimedia asset at the user equipment; and
a third module for, in response to receiving the signal indicative of the QoE reporting trigger, providing a first layer report, including data representative of the first value, for wireless transmission from the user equipment to an eNB.

2. The user equipment of claim 1, wherein the QoE reporting trigger occurs based on a comparison of the first value to a predetermined threshold for the first QoE metric.

3. The user equipment of claim 2, wherein the predetermined threshold for the first QoE metric is a buffer occupancy threshold value transmitted to the user equipment from the eNB.

4. The user equipment of claim 1, wherein the QoE reporting trigger initiates a periodic reporting of QoE metrics from the user equipment for a specified duration of time or until signaled otherwise.

5. The user equipment of claim 1, wherein the QoE reporting trigger includes a QoE reporting request signal received at the user equipment from an eNB.

6. The user equipment of claim 5, wherein the QoE reporting request signal includes an absolute time stamp value and the first layer report includes a relative time stamp value indicative of a logging time of the first value, the relative time stamp value relative to the absolute time stamp value.

7. The user equipment of claim 1, wherein the first value of the first QoE metric is a filtered value based on two or more measurements of the first QoE metric.

8. The user equipment of claim 1, wherein the first QoE metric is selected from the group consisting of a playout buffer occupancy measurement, a rebuffering percentage measurement, a frame loss percentage, a rate distortion characteristic, a video quality metric, a peak signal-to-noise ratio, a structural similarity metric, a perceptual evaluation of video quality metric, a video mean opinion score, and an initial playout delay.

9. A user equipment comprising circuitry configured to:
receive at a first layer in a protocol stack of the user equipment, from a second layer above the first layer in the protocol stack, a first value of a first quality of experience (QoE) metric computed during playout of a multimedia asset at the user equipment; and
provide a first layer report, including data representative of the first value, for wireless transmission from the user equipment to an eNB.

10. The user equipment of claim 9, wherein the first layer is a physical (PHY) layer.

11. The user equipment of claim 10, wherein the data representative of the first value includes a one-bit indicator to provide an indication of a playout buffer occupancy with respect to a predetermined playout buffer occupancy threshold.

12. The user equipment of claim 10, wherein provide a first layer report occurs periodically with a period of approximately 10 milliseconds or less.

13. The user equipment of claim 10, wherein the first layer report also includes channel state information (CSI).

14. The at user equipment of claim 10, wherein the first layer report is provided for wireless transmission in a physical uplink control channel (PUCCH) between the user equipment and the eNB.

15. The user equipment of claim 10, wherein the first layer report is provided for wireless transmission in a physical uplink shared channel (PUSCH) between the user equipment and the eNB.

16. The user equipment of claim 15, wherein the circuitry is further configured to:
receive, in an uplink grant corresponding to the PUSCH, a request for aperiodic feedback of QoE information.

17. The user equipment of claim 16, wherein the first layer report includes an absolute amount of playout buffer occupancy or a re-buffering percentage.

18. The user equipment of claim 16, wherein the request is also for aperiodic feedback of channel state information (CSI).

19. The user equipment of claim 9, wherein the first layer is a medium access control (MAC) layer.

20. The user equipment of claim 19, wherein provide a first layer report occurs periodically with a period between approximately 100 ms and 1 s.

21. The user equipment of claim 19, wherein the first layer report is provided for wireless transmission in a MAC control element.

22. The user equipment of claim 21, wherein the MAC control element is transmitted in an uplink shared channel and includes a logical channel identity (LCID) value to indicate reporting of a QoE metric.

23. The user equipment of claim 9, wherein the first layer is a radio resource control (RRC) layer.

24. The user equipment of claim 23, wherein provide a first layer report occurs periodically with a period greater than approximately 2 seconds.

25. The user equipment of claim 9, wherein the second layer is an application layer.

26. At least one machine-accessible medium comprising instructions stored thereon that are configured to cause an eNB, in response to execution of the instructions by the eNB, to:
transmit, to a wireless device served by the eNB, data representative of a multimedia asset for playout at the wireless device;
transmit, for communication to a first layer of a protocol stack of the wireless device below an application layer of the wireless device, a quality of experience (QoE) reporting trigger signal; and
receive, from the wireless device in response to the QoE reporting trigger signal, a first layer report including data representative of the values of one or more QoE metrics logged at the application layer of the wireless device during playout of the multimedia asset.

27. The at least one machine-accessible medium of claim 26, further comprising instructions stored thereon that are configured to cause an eNB, in response to execution of the instructions by the eNB, to:
adjust a schedule for delivery of data representative of the multimedia asset based at least in part on the data representative of the values of the one or more QoE metrics in the first layer report.

28. The at least one machine-accessible medium of claim 26, wherein playout of the multimedia asset comprises buffered streaming of the multimedia asset and the one or more QoE metrics includes a rebuffering percentage.

29. The at least one machine-accessible medium of claim 26, further comprising instructions stored thereon that are configured to cause the eNB, in response to execution of the instructions by the eNB, to:
transmit, for communication to the first layer of the protocol stack of the wireless device, a channel state information (C SI) feedback mode message indicating which QoE metrics are to be included in the first layer report.
